(19) United States
(12) Patent Application Publication
(10) Pub. No.: US 2020/0213135 A1
(43) Pub. Date: Jul. 2, 2020

(54) SYSTEM AND METHOD FOR SECURE MANUFACTURING OF ARTICLES

(71) Applicant: Unbound Tech Ltd, Petah Tiqva (IL)

(72) Inventors: George Wainblat, Tel Mond (IL); Oz Mishli, Kfar Saba (IL); Guy Pe'er, Talmey Yechiel (IL); Valery Osheter, Ashdod (IL); Saar Pe'er, Oranit (IL); Michael Kraitsberg, Rehovot (IL); Alexander Presman, Ramat-Gan (IL); Yaniv Refael, Ness Ziona (IL)

(73) Assignee: Unbound Tech Ltd, Petah Tiqva (IL)

(21) Appl. No.: 16/237,061

(22) Filed: Dec. 31, 2018

(51) Int. Cl. H04L 9/32; H04L 9/08

(52) U.S. Cl. CPC H04L 9/3263; H04L 9/0819; H04L 9/3252; H04L 9/3249

(57) ABSTRACT

The claimed subject matter discloses system for securing a process of manufacturing an article, comprising a facility security node located in a manufacturing facility where the article is manufactured, a security server located remotely from the manufacturing facility, said security server communicates with the facility security node and comprises a key generation module configured to generate a certificate authority (CA) private key in a split manner, one share of the CA private key is stored at the security server and another share of the CA private key is stored at the manufacturing facility. The server also comprises a server Multi-Party Computation (MPC) module configured to perform an MPC process with an article MPC module stored at the article, the output of the MPC process is signing the certificate without reconstructing the entire CA private key.

### FIELD OF THE INVENTION

The present disclosure generally relates to manufacture of articles, and more particularly relates to securing information when manufacturing articles.

### BACKGROUND OF THE INVENTION

Manufacturing is an important component in the global economy, contributing 16% of worldwide GDP and 14% of total employment. Global manufacturers use advanced manufacturing technology to improve cost competitiveness, enhance processes and maintain connectivity with their supplier ecosystem. In the current global economy, with off-shore manufacturing gaining an increased international presence, many organizations face significant challenges for managing complex global operations with distinct divisions of labor between various offshore manufacturing sites.

Risks and concerns associated with offshore manufacturing include lack of control, as current provisioning methods expose manufacturers to liability and risks for any security breach that occurs within their supply chain. Such security breach may result from intellectual property (IP) theft, blueprints, security keys embedded in electronic devices, production of black-market replicas, producing identical products containing malware and others.

### SUMMARY OF THE INVENTION

It is an object of the subject matter to disclose a system for securing a process of manufacturing an article, comprising a facility security node located in a manufacturing facility where the article is manufactured, a security server located remotely from the manufacturing facility, said security server communicates with the facility security node and comprises a key generation module configured to generate a certificate authority (CA) private key in a split manner, one share of the CA private key is stored at the security server and another share of the CA private key is stored at the manufacturing facility, a server Multi-Party Computation (MPC) module configured to perform an MPC process with an article MPC module stored at the article, the output of the MPC process is signing the certificate without reconstructing the entire CA private key.

In some cases, the security server is connected to multiple distinct manufacturing facilities, and is configured to secure manufacturing processes in the multiple distinct manufacturing facilities. In some cases, the security server further comprises a usage log configured to store metadata associated with generation of the CA private key for each article manufactured in the manufacturing facility. In some cases, the CA private key is an elliptical curve signing key. In some cases, the CA private key is an RSA key. In some cases, the facility security node is a software module operating in a manufacturing machine in the manufacturing facility.

In some cases, the security server further comprises share usage rules module configured to store usage rules associated with usage or the shares of CA private keys generated by the security server and a processing module configured to determine whether or not to sign the CSR based on the usage rules.

It is an object of the subject matter to disclose a method for securing a process of manufacturing an article, comprising installing a facility security node located in a manufacturing facility and a security server communicatively coupled to the facility security node and located remotely from the manufacturing facility, generating a certificate authority (CA) private key in a split manner, storing one share of the CA private key at the security server and another share of the CA private key at the manufacturing facility and performing an MPC process with an article MPC module stored at the article, the output of the MPC process is signing the certificate without reconstructing the entire CA private key.

### BRIEF DESCRIPTION OF THE DRAWINGS

The invention may be more clearly understood upon reading of the following detailed description of non-limiting exemplary embodiments thereof, with reference to the following drawings, in which:

FIG. 1 discloses a computerized environment having the security server and multiple manufacturing sites, according to exemplary embodiments of the subject matter;

FIG. 2 discloses a security server located remotely from the manufacturing sites and configured to secure information split between the security server and the manufacturing facilities, according to exemplary embodiments of the subject matter;

FIG. 3 shows a method for authorizing cryptographic keys embedded in the manufactured devices, according to exemplary embodiments of the subject matter;

FIGS. 4A-4B show methods for securing design plans of the manufactured device, according to exemplary embodiments of the subject matter; and,

FIG. 5 shows a method of controlling a number of manufactured units of a specific article, according to exemplary embodiments of the subject matter.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION OF THE INVENTION

Illustrative embodiments of the invention are described below. In the interest of clarity, not all features/components of an actual implementation are necessarily described.

The subject matter discloses a system and method for validating security keys included in devices when manufacturing the devices. The subject matter also discloses methods for controlling the number of units manufactured in remote manufacturing facilities and methods for controlling design plans used to manufacture articles in the manufacturing facilities. The system comprises a security server, for example stored at a headquarters residence of the company regulating the manufacturing process, and a facility security node operating in the manufacturing facility. The facility security node may be multiple nodes, implemented as software, firmware or hardware, embodied in multiple different machines configured to manufacture articles in the manufacturing facility. The facility security node is communicatively coupled to the security server. When there are multiple facility security nodes, each facility security node may be communicatively coupled to a distinct module in the security server. The keys are generated in the manufacturing facility on the articles, for example a unique cryptographic private-public key pair for each article, and is validated by performing an MPC process between the manufacturing facility and the security server as elaborated below.

Each of the manufacturing facility and the security server stores a share of an issuing Certificate Authority (CA) key, as well as the entire CA chain (root, intermediary, issuing). The CA key is configured to validate the key stored in the manufactured article with a signed certificate. The shares of the issuing CA key, as well as the entire CA chain (root, intermediary, issuing) may be generated using a multi-party computation (MPC) process. The manufacturing facility and the security server also store a set of instructions to be executed in response to receiving a request to authorize the key in the manufactured article and complete the article's provisioning. The instructions performed by the nodes are detailed below. Both the manufacturing facility and the security server comprises a communication module configured to exchange messages with the other party. The communication modules may exchange signals via wireless or wired channels, for example via the internet, on cables, via a cellular network or any communication technique desired by a person skilled in the art. The manufacturing facility and the security server also comprise a memory unit configured to store a set of instructions to be executed. When a single security server interacts with multiple facility security node, the messages received from the multiple facility security node may be associated with an identifier of the specific facility security node of the multiple facility security node.

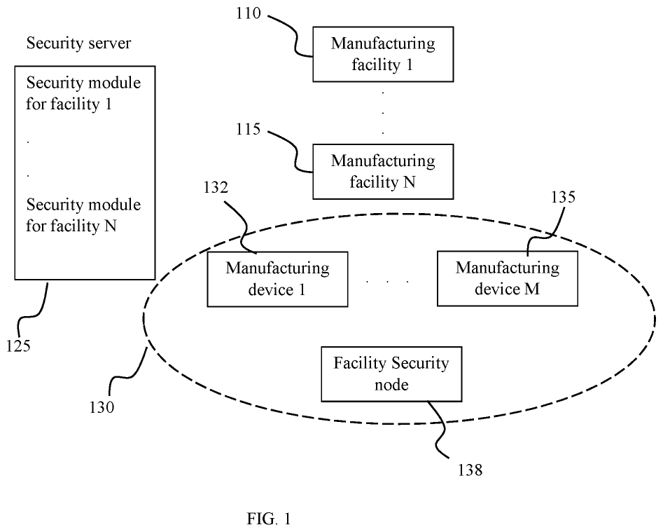

FIG. 1 discloses a computerized environment having the security server and multiple manufacturing sites, according to exemplary embodiments of the subject matter. The computerized environment shows a security server 125 configured to regulate manufacture of articles in one or more manufacturing facilities. In some cases, security server 125 comprises multiple nodes, each of the nodes is configured to communicate with a specific facility security nodes located in the multiple manufacturing facilities. In some exemplary cases, the security server 125 is physically or virtually divided into multiple sub-units, each sub-unit may be allocated to regulating manufacture of a manufacturing facility, or a specific manufacturing machine in a manufacturing facility. For example, each of the manufacturing machines may be configured to utilize keys from a different partition. The security server 125 may communicate with the manufacturing facilities over the internet or via any other technique desired by a person skilled in the art.

The computerized environment also shows multiple manufacturing facilities, from the first manufacturing facility 110 to the Nth manufacturing facility 115. The multiple manufacturing facilities may manufacture different articles, may be located in different locations, sometimes different continents. In some cases, the multiple manufacturing facilities may use different manufacturing methods for manufacturing the same article, or articles in the same technological field. In some cases, a single manufacturing facility comprises multiple manufacturing devices. For example, the i^{th} manufacturing facility 130 may comprise multiple manufacturing devices, from the first manufacturing device 132 to the M^{th} manufacturing device 135. The i^{th} manufacturing facility 130 may comprise one or more facility security nodes communicating with the security server 125. In some exemplary cases, each of the manufacturing devices has a facility security nodeembodied therein and regulating the manufacturing process as elaborated below. In some cases, the facility security node may be used to perform more than one of the methods of regulating manufacturing, for example both validate cryptographic keys and prevent manufacture of excess amount of articles.

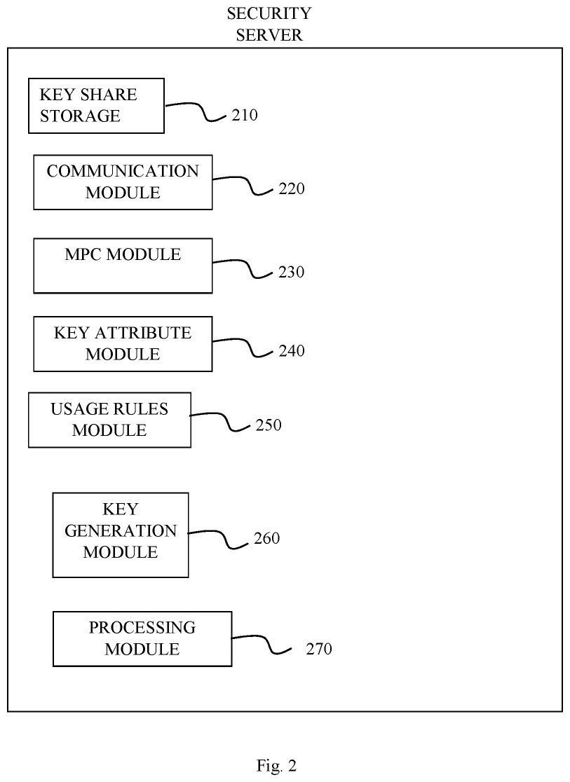

FIG. 2 discloses a security server configured to secure information in manufacturing sites, according to exemplary embodiments of the subject matter. The security server comprises a key share storage 210 configured to store key shares of Certificate Authority (CA) keys. The CA keys are divided in a manner that the entire CA keys are never reconstructed and yet can be used to complete a signing request process. The CA key shares in the key share storage 210 are shared between the security server and the manufacturing facility. The CA key shares are generated by a key generation module 260, configured to generate two shares of the CA keys using mathematical computation. The key generation module 260 outputs one share of the key to the key share storage 210 and another share of the key to the facility security node of the manufacturing facility. The key share storage 210 may store an identifier of the manufacturing facility as an attribute of the key. In some cases, the key share storage 210 may store an identifier of a manufacturing machine and/or the manufacturing facility. The identifier may later be used when completing the signing request process. The key share storage 210 may be a database, a storage server communicating with the security server or embodied therein, may comprise volatile memory, non-volatile memory or any type of electrical memory used in the electrical or computer industry for storing information.

The security server also comprises a communication module 220 configured to communicate with external entities, for example with the facility security node of the manufacturing facility. The communication module 220 may comprise an internet gateway, a modem, an antenna, or use communication infrastructure in the facility where the security server is located. The communication module 220 may convert the messages received from another entity to a predefined format configured to be processed by the processing module 270 of the security server.

The security server also comprises an MPC module 230. The MPC module 230 may be used upon request from the processing module 270. The MPC module 230 of the security server is configured to perform an MPC process with an MPC module located in another entity, for example a manufacturing MPC module located in a facility security node of the manufacturing facility. The MPC process may be used to complete a certificate signing process and validate the security key included in the manufactured article, thus provisioning the article. The MPC module 230 is configured to exchange messages during the MPC process, for example via the communication module 220.

The security server also comprises a key attribute module 240 configured to store prior usage of the security server. Examples of such usage may be sending information related to design plan of an article, completing a certificate signing process and provisioning an article, approving manufacture request for a predefined amount of articles, and the like. The key attribute module 240 may store information associated with multiple manufacturing facilities, for example the total number of signing processes for each manufacturing facility, articles provisioned in a predefined time duration, manufacture failures, alerts concerning device provisioning and the like.

The security server also comprises a usage rules module 250 configured to store usage rules for manufacturing articles in the manufacturing facilities communicating with the security server. One example for the usage rule may be limiting the number of signing requests from a manufacturing facility to a predefined number, thus limiting the number of provisioned articles. Another example of usage rules is to allow a maximum of three manufacture batches per day for a specific manufacturing machine in a manufacturing facility. Thus, when the security server receives a request to complete a signing process, the processing module 270 may first verify that the request to complete a signing process qualifies with the usage rules in the usage rules module 250, and then command the MPC module 230 to complete the signing process.

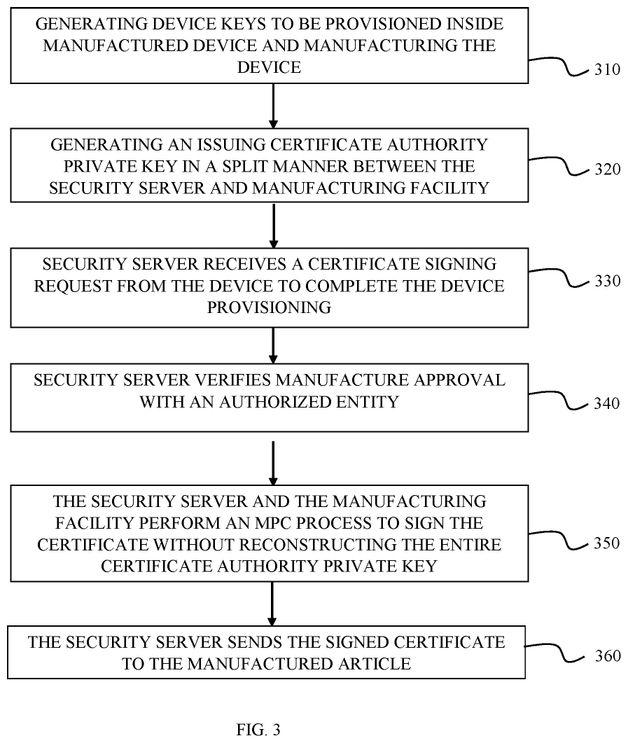

FIG. 3 shows a method for authorizing cryptographic keys embedded in the manufactured devices, according to exemplary embodiments of the subject matter.

Step 310 discloses generating article keys to be provisioned inside manufactured article and manufacturing the article. The keys may be generated by a key generation module in the manufacturing facility. The key generation module may be regulated by a facility security node interacting with the security server. The device keys may be unique to each and every article to which they are generated. The device keys are stored in a memory address in the manufactured article. The device keys may be stored in an external module such as a disk. In some cases, communication properties of the security server, such as an email address or an IP address may also be stored in the memory of the manufactured article.

Step 320 discloses generating an Issuing Certificate Authority (CA) private key in a split manner between the security server and manufacturing facility. The CA key is never reconstructed during any step of the processes disclosed herein. The CA key is generated in a split manner, and is not split from the entire key. One share of the CA key is stored in the security server and another share of the CA key is stored in the manufacturing facility. The security server may store metadata related to the CA key, for example identifier of the manufacturing facility, due date for using the CA key and the like.

Step 330 discloses security server receives a certificate signing request from the device to complete the device provisioning. The certificate signing request may be received at an IP address, via a message sent to a dedicated software application and the like. The certificate signing request may comprise metadata associated with the request, such as article-related information, identifier of the manufacturing facility or manufacturing device and the like. The identifier may be used to confirm that the request is valid, and that the security server should participate in the MPC process with the appropriate entity.

Step 340 discloses security server verifies manufacture approval with an authorized entity. The authorized entity may be a person entitled to regulate manufacturing, or the usage rules stored in usage rules module 250 as elaborated above. Verifying manufacture approval may be implemented by sending the certificate signing request to the processing module, which compares the certificate signing request with the relevant rules in the usage rules module 250 and receives approval or denial concerning the certificate signing request.

Step 350 discloses the security server and the manufacturing facility perform an MPC process to sign the certificate without reconstructing the entire issuing certificate authority private key. The MPC process is performed by exchanging information between the security server and a facility security node in the manufacturing facility until a predefined condition is met, indicating that the two parties, the security server and the manufacturing facility, contain two shares of the same CA key, thus signing the certificate before the certificate authority.

Step 360 discloses the security server sending the signed certificate to the manufactured article.

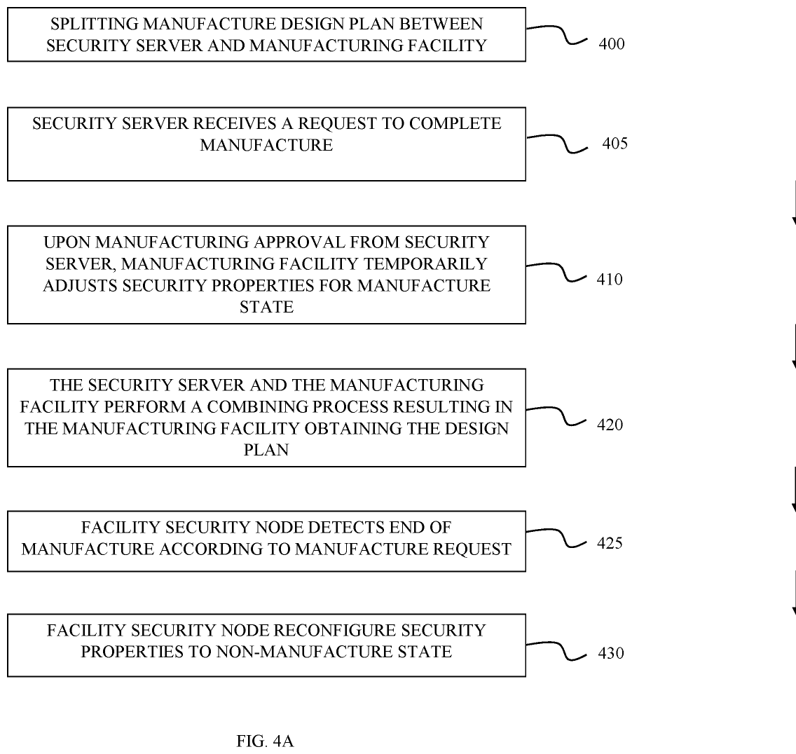

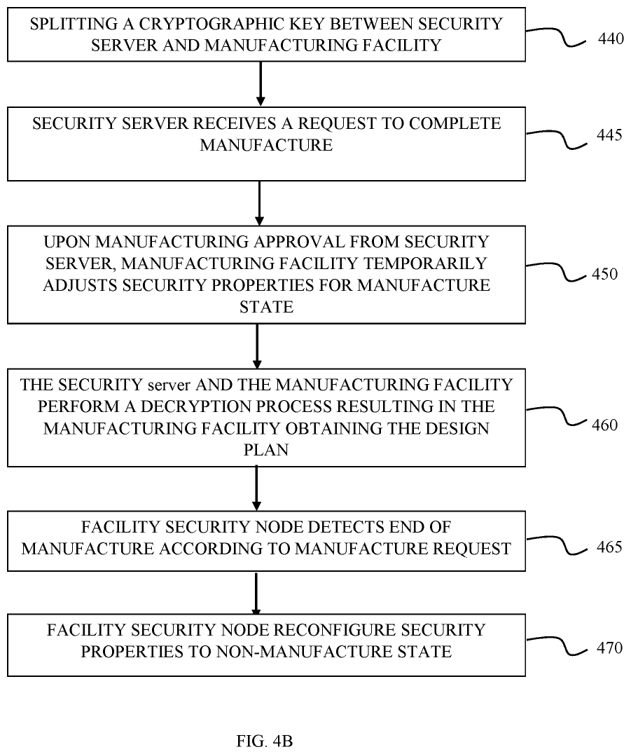

FIG. 4A shows a method for securing design plans of the manufactured device by splitting the manufacture design plan, according to exemplary embodiments of the subject matter.

Step 400 discloses splitting manufacture design plan between security server and manufacturing facility.

Step 405 discloses security server receives a request to complete manufacture. The request may be sent to a specific address known to the manufactured article. The specific address is provided to the manufactured article by the manufacturing machine and is stored in a known memory address in the memory of the manufactured article. As part of provisioning the article, the article is configured to perform a set of instructions stored in the article's memory. One of the instructions is to generate a manufacturing request and send the request to the specific address, which is received by the security server.

Step 410 discloses upon manufacturing approval from security server, manufacturing facility temporarily adjusts security properties for manufacture state. The security properties may limit access to the memory of a manufacturing device in the manufacturing facility, limiting access to a communication network in the manufacturing facility, utilizing enclaves, activating software or hardware security modules and the like. The manufacture state may be activated and deactivated by the facility security node in the manufacturing facility.

Step 420 discloses the security server and the manufacturing facility perform a combining process that uses the two shares of the manufacturing design plan. The combining process resulting in the manufacturing facility obtaining the design plan. The combining process may be an MPC process, in which each none of the entities hold the entire design plan prior to the manufacturing approval, and the output of the MPC process is the manufacturing facility obtaining a plain text version of the design plan.

Step 425 discloses facility security node detecting end of manufacture according to manufacture request. The manufacture request may comprise a number of articles to be manufactured. As the facility security node resides in the manufacturing facility, the facility security node may periodically sample a memory address counting the number of articles manufactured, or receive a manufacturing indication from the manufacturing machine.

Step 430 discloses facility security node reconfigure security properties to non-manufacture state. The facility security node may send commands to software and/or hardware modules which have been adjusted when entering the manufacture state as disclosed in step 410.

FIG. 4B show a method for securing design plans of the manufactured device by splitting the key controlling usage of the manufacture design plan, according to exemplary embodiments of the subject matter.

Step 440 discloses splitting a cryptographic key between security server and the manufacturing facility. The cryptographic key may be generated in a split manner, as elaborated above.

Step 445 discloses the security server receives a request to complete manufacture. This step is equivalent to step 405 of FIG. 4A. Step 450 discloses upon manufacturing approval from security server, manufacturing facility temporarily adjusts security properties for manufacture state. This step is equivalent to step 410 of FIG. 4A.

Step 460 discloses the security server and the manufacturing facility perform a decryption process resulting in the manufacturing facility obtaining the design plan. This step is equivalent to step 420 of FIG. 4A. Step 465 discloses facility security node detecting end of manufacture according to manufacture request. This step is equivalent to step 425 of FIG. 4A. Step 470 discloses the facility security node reconfigure security properties to non-manufacture state. This step is equivalent to step 430 of FIG. 4A.

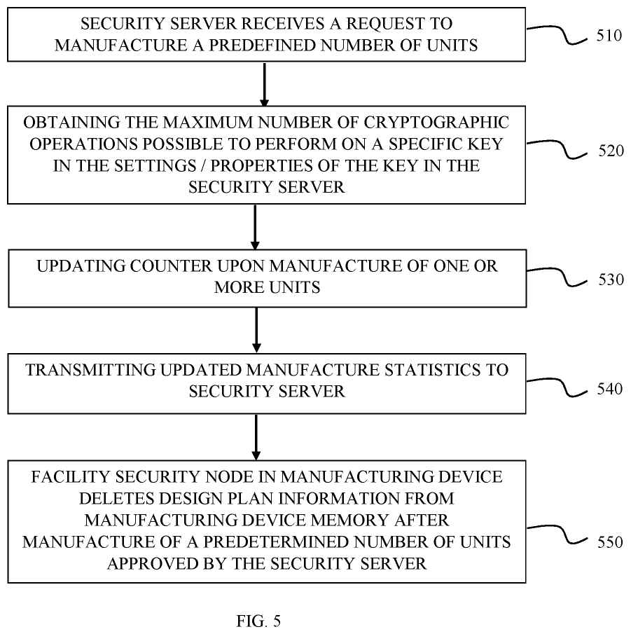

FIG. 5 shows a method of controlling a number of manufactured units of a specific article, according to exemplary embodiments of the subject matter.

Step 510 discloses the security server receiving a request to manufacture a predefined number of units. The request may be sent from a single manufacturing machine or from multiple manufacturing machines, for example via an email message or via a request in a dedicated software portal. The request may include identifier of the article to be manufactured. The request may be received at the communication module of the security server.

Step 520 discloses obtaining the maximum number of cryptographic operations possible to perform on a specific key according to the key attributes as stored in the security server. The maximal number of cryptographic operations may be stored in a database of the usage rule module 250. For example, manufacturing facility “A” may be allowed 33 cryptographic operations possible to perform on a specific key per month, while manufacturing facility “B” may be allowed 500 cryptographic operations possible to perform on a specific key per day.

Step 530 discloses updating counter upon manufacture of one or more units. The counter may be stored in a memory address in the manufacturing facility, the memory address may be accessible to a computerized software communicating with the security server, for example the facility security node.

Step 540 discloses transmitting updated manufacture statistics to security server. The manufacture statistics may be transmitted by the computerized software communicating with the security server. The manufacture statistics may include number of manufactured articles, manufacture duration, machines used to manufacture the articles, inventory information, alerts in case the manufacture duration exceeds a predefined range of values and the like.

Step 550 discloses facility security node in the manufacturing device deletes design plan information from manufacturing device memory after manufacture of a predetermined number of units approved by the security server. The manufacturing machine is required to store the design plan information in a manner that is accessible to the facility security node in order to manufacture the articles. For example, the facility security node operating in the manufacturing machine may disable manufacture unless the design plan is stored in a specific memory address. After manufacture which satisfies predefined conditions, such as number of articles, the facility security node accesses the memory address and deletes the design plan information.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

1. A system for securing a process of manufacturing an article, comprising:
a facility security node located in a manufacturing facility where the article is manufactured;
a security server located remotely from the manufacturing facility, said security server communicates with the facility security node and comprises:
a key generation module configured to generate a certificate authority (CA) private key in a split manner, one share of the CA private key is stored at the security server and another share of the CA private key is stored at the manufacturing facility;
a server Multi-Party Computation (MPC) module configured to perform an MPC process with an article MPC module stored at the article, the output of the MPC process is signing the certificate without reconstructing the entire CA private key.

2. The system of claim 1, wherein the security server is connected to multiple distinct manufacturing facilities, and is configured to secure manufacturing processes in the multiple distinct manufacturing facilities.

3. The system of claim 1, wherein the security server further comprises a usage log configured to store metadata associated with generation of the CA private key for each article manufactured in the manufacturing facility.

4. The system of claim 1, wherein the CA private key is an elliptical curve signing key.

5. The system of claim 1, wherein the CA private key is an RSA key.

6. The system of claim 1, wherein the facility security node is a software module operating in a manufacturing machine in the manufacturing facility.

7. The system of claim 1, wherein the security server further comprises share usage rules module configured to store usage rules associated with usage or the shares of CA private keys generated by the security server and a processing module configured to determine whether or not to sign the CSR based on the usage rules.

8. A method for securing a process of manufacturing an article, comprising:
installing a facility security node located in a manufacturing facility and a security server communicatively coupled to the facility security node and located remotely from the manufacturing facility;
generating a certificate authority (CA) private key in a split manner;
storing one share of the CA private key at the security server and another share of the CA private key at the manufacturing facility;
performing an MPC process with an article MPC module stored at the article, the output of the MPC process is signing the certificate without reconstructing the entire CA private key.
